(19) United States
(12) Patent Application Publication
(10) Pub. No.: US 2014/0022598 A1
(43) Pub. Date: Jan. 23, 2014

(54) REPRODUCTION SYSTEM FOR PRINTING AND COPYING DIGITAL DOCUMENTS

(71) Applicant: OCE TECHNOLOGIES B.V., Venlo (NL)

(72) Inventor: Marinus P. NEELEMAN, Nijmegen (NL)

(73) Assignee: OCE TECHNOLOGIES B.V., Venlo (NL)

(21) Appl. No.: 14/035,084

(22) Filed: Sep. 24, 2013

Related U.S. Application Data
(63) Continuation of application No. PCT/EP2012/054072, filed on Mar. 9, 2012.

(30) Foreign Application Priority Data
Mar. 25, 2011 (EP) 11159780.3

(51) Int. Cl. G06F 3/12

(52) U.S. Cl. CPC G06F 3/1296
USPC 358/1.15

(57) ABSTRACT

A reproduction system includes a printer for printing a print job on receiving material in accordance with a set of values for a plurality of basic settings, a control for controlling the print job in order to print the print job, and a display and activating device for displaying a visual representation of settings for the print job and for activating values of the basic settings for the print job. The control is configured to define a plurality of settings categories each of which is directed to an aspect of the print product and includes a predetermined category option which determines a set of values for a plurality of basic settings, the category options for the settings categories together completely describing the print product. The display and activating device is configured to simultaneously display the complete plurality of settings categories, each settings category showing the corresponding category option.

### CROSS-REFERENCE TO RELATED APPLICATIONS

This application is a Continuation of International Application No. PCT/EP2012/054072, filed on Mar. 9, 2012, and for which priority is claimed under 35 U.S.C. § 120, and which claims priority under 35 U.S.C. § 119 to Application No. 11159780.3, filed in Europe on Mar. 25, 2011. The entirety of each of the above-identified applications is expressly incorporated herein by reference.

### BACKGROUND OF THE INVENTION

1. Field of the Invention

The present invention relates to a reproduction system comprising at least one printer for printing a print job on receiving material resulting in a print product in accordance with a set of values for a plurality of basic settings, said values associated with the print job, a control device configured to control the print job in order to print the print job by the at least one printer according to the set of values of the basic settings, and a display and activating device configured to display on a screen a visual representation of settings for the print job and activate values of the basic settings for the print job.

2. Background of the Invention

A reproduction system of this kind is known, in which a copying and printing apparatus is described which is provided with a touch screen displaying icons for basic settings of a current print job or a print job selected from a queue. The basic settings of the print job determine a print product printed by the reproduction system. On the other hand, the reproduction system may comprise a workstation comprising an application, e.g. a printer driver, provided with a screen displaying the basic settings.

If a large number of basic settings are available, a large number of icons are required. The user is then faced with a large amount of visual information from which he must make a selection. Usually these icons are not displayed simultaneously but behind selectable tabs on the screen. In that case, a user will also have to navigate between different display windows for each tab selection. This increases the risk of the user no longer having an overview of the settings that have been made and which can still be made. In addition, to navigate between different windows, a user must carry out extra operations.

### SUMMARY OF THE INVENTION

The reproduction system according to the present invention obviates these disadvantages, wherein the control device is configured to define a plurality of settings categories, each of which is directed to an aspect of the print product and includes a predetermined category option, which determines a set of values for a plurality of basic settings, said category options for the settings categories together completely describing the print product, and the display and activating device is configured to simultaneously display the complete plurality of settings categories, each settings category showing the corresponding category option.

Many basic settings are needed to define a desired print product. To ease the definition for the user, an in-between layer of settings categories has been created, which are displayed at the display and activating device by means of predetermined category options. Each settings category describes a specific aspect of the print product. Each settings category comprises at least one possible option for that category. A category option may influence more than one basic setting. For example, a booklet category option may influence the basic settings 2-up, double- or single-sided, folding, staple and sequence order of pages. By doing so, all basic settings are comprised in a plurality of category options, which are much less in number than the plurality of basic settings. The category options are divided into a small number of settings categories. Usually, the user knows the settings category to which a desired category option is associated, because the settings category represents a specific aspect of the print product. Since a number of category options belonging to a settings category is not very large in comparison to the total number of basic settings, the desired category option is easily found at the number of category options associated to the settings category.

The present invention will be described for a print job, but the present invention is not limited to print jobs. The present invention may also be applied to copy jobs.

According to an embodiment of the reproduction system, each settings category has a selection list of category options. Such a list may be mutually exclusive for the plurality of settings categories. The list is not exhaustive and may also be adjustable by the user. Each settings category has a predetermined category option. However, the predetermined category option may be changed by activating the displayed settings category, e.g. by touching of or clicking on the displayed settings category, in order to select another category option from the selection list that will appear after activation.

This is advantageous in order to help the user of the reproduction system to select the right and unique settings category to which a desired category option belongs.

According to an embodiment of the reproduction system, the display and activating device is configured to display on one window each settings category by means of an icon of the predetermined category option associated with the settings category. This is advantageous, since it becomes immediately visible which category option is the predetermined category option for the corresponding settings category.

According to a further embodiment of the reproduction system, the display and activating device is configured to display the plurality of basic settings in the one window upon user command. By displaying the basic settings in the one window, the user is immediately able to get a complete overview of the basic settings and does have to navigate to other windows, for example via tabs.

According to a further embodiment of the reproduction system, the display and activating device is adapted to show the selection list of a settings category upon user command, when activating the icon of the settings category, and to activate a category option from the shown selection list. The selection of a category option from the list results in another desired category option for the print job to be printed.

According to a further embodiment of the reproduction system, the display and activating device is adapted to simultaneously display the selected category options and the plurality of basic settings in one window upon user command. By displaying the basic settings and the selected category options in the one window, the user is immediately able to see a correspondence between a selected category option and the values of its underlying basic settings.

According to a further embodiment of the reproduction system, the display and activating device is configured to create a new category option by saving values of current basic settings. The display and activating device may be configured to show a save unit at the icon of a settings category. A new category option of said settings category may be created upon activation of the save unit. The save unit may be activated by touching of the save unit or by clicking on the save unit. This is advantageous, since it is possible to create a new category option, when a value of an involved basic setting is changed. When a new category option belonging to a settings category is created, it is added to the list of category options belonging to that settings category.

According to a further embodiment of the reproduction system, a settings category is directed to one print aspect from media, layout, image, finishing and delivery of the print product. The combination of the category options of all settings categories is sufficient to completely determine a print product. On the other hand, each basic setting is related to at least one of these print aspects.

Another aspect of the present invention is a method for printing a print job on a reproduction system resulting in a print product according to a plurality of print aspects describing the complete print product, wherein the method comprises the steps of receiving the print job and values of basic settings associated with the print job at a reproduction system, representing each print aspect of the print product by a settings category including a plurality of category options, for each settings category defining a category option corresponding to values of the basic settings of the print job, simultaneously displaying the settings categories and the corresponding category options, and printing the print job according to current category options.

A further embodiment of the method comprises the additional steps of displaying each settings category by means of an icon representing its corresponding category option, displaying the plurality of basic settings and the category options in one window upon user command, displaying a selection of category options for a settings category upon user command, and changing and saving a category option of a settings category upon user command.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing one possible configuration of a reproduction system;

FIG. 2 illustrates a remote control device for a reproduction system;

FIG. 3 is a diagram of another configuration of a reproduction system;

FIGS. 4-8 illustrate in greater detail embodiments of the windows on the display of a reproduction system, when processing a print job; and

FIG. 9 is a flow diagram of an embodiment of the method according the present invention.

### DETAILED DESCRIPTION OF THE PREFERRED EMBODIMENTS

The present invention will now be described with reference to the accompanying drawings, wherein the same or similar elements are identified with the same reference numeral.

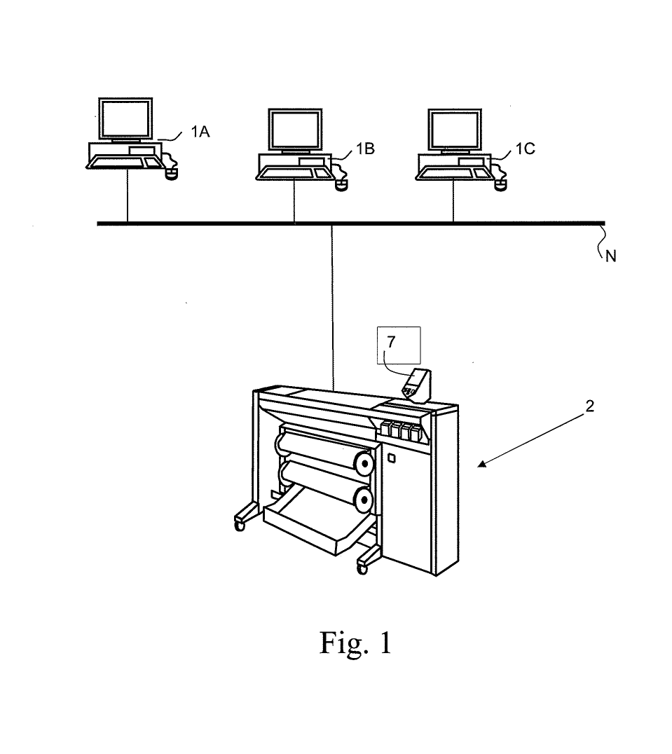

FIG. 1 shows a reproduction system comprising workstations 1A-1C connected to a local network N. The present invention is particularly suited for use in this kind of environment, where a reproduction apparatus 2 is available for a user working with one of the workstations 1A-1C and intending to send a print job comprising a set of documents from one of the workstations 1A-1C to the reproduction apparatus 2. The reproduction apparatus 2 is connected to the network N and suited for receiving print jobs from the workstations 1A-1C. The network N may be wireless.

The reproduction apparatus 2 comprises a user interface 7 suitable for displaying and selecting print jobs and their settings.

In an embodiment, each of the workstations 1A-1C is a personal computer provided with a processor unit, a display unit, a keyboard and a mouse or any other input device in order to enable a user, who is logged in on a workstation, to dispatch one or more print jobs to the reproduction apparatus 2. The dispatching may be done by means of a printer driver installed on one of the workstations 1A-1C. Such a printer driver may also be adapted to display the settings categories and the basic settings. The reproduction apparatus may be a printer for small and/or wide format documents.

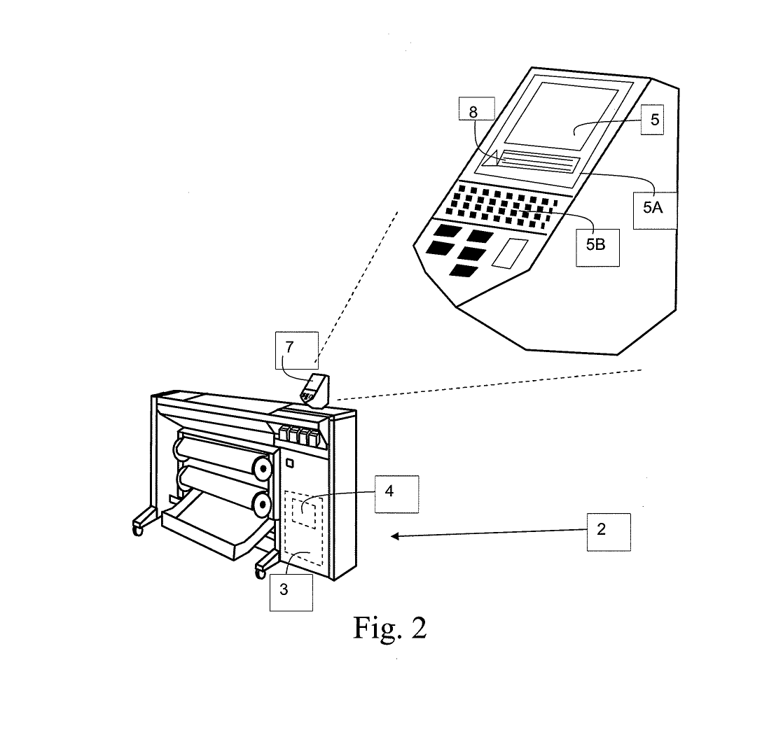

In an embodiment, shown in FIG. 2, the reproduction apparatus 2 comprises a local user interface 7 and a control unit 3 comprising a storing device 4 such as a hard disk, and is further connected to a display and activating device. The display and activating device may be separate devices, such as the display device 5A and input device 5B in FIG. 2. The input device 5B may be a keyboard for enabling a user to enter commands in order to execute printing of digital documents. Alternatively, the display and activating device may be realized in the form of a single or double touch screen. How the reproduction apparatus 2 is used in relation to the present invention will be elucidated further on.

The control unit 3 is suited to queue print jobs, to check whether or not the print queue is empty and to submit a document from a queued print job to the print engine of the reproduction apparatus 2 in order to be printed. Documents of a print job are stored in the storing device 4 contained in the control unit 3 at least for the time period that the document is printed by the print engine and finished by a finisher.

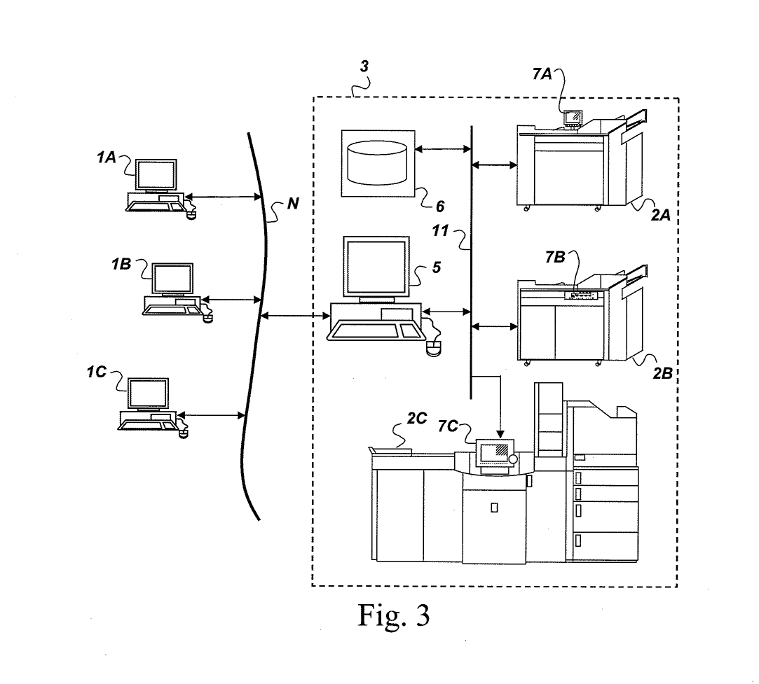

FIG. 3 shows another general reproduction system including user workstations 1A-1C (e.g., PCs) and a centralized printing facility 3, all connected by a network N such as a Local Area Network, or even the Internet. The centralized printing facility includes a plurality of reproduction apparatuses 2A-2C and a work station 5, which may include a server operating system or a normal operating system for a PC. The centralized printing facility may also include a document database 6 or be connected to a central database facility acting as a document database. The devices in the centralized printing facility are interconnected by a local network 11, which may be part of the general network N.

In operation, users prepare documents on their workstations and submit the resulting document data files to the centralized printing facility for printing and possibly storage in the database 6.

The files for printing are received by the server 5 and are, under the control of a user or operator, transferred to a printer device 2A-2C.

The server 5 runs program software and so forms a system for editing and specifying the print processing of the print job that produces the prints according to the document file submitted by the users.

Each reproduction apparatus 2A-2C has a local user interface 7A-7C. A first reproduction apparatus 2A comprises a local user interface 7A mounted on top of the reproduction apparatus 2A. A second reproduction apparatus 2B comprises a local user interface 7B integrated in a front panel of the reproduction apparatus 2B. A third reproduction apparatus 2C comprises a local user interface 7C having a touch screen mounted on top of the reproduction apparatus 2C.

When a print job arrives at the reproduction apparatus 2 according to FIG. 1 or the reproduction apparatus 2A-2C according to FIG. 2, and the job is ready to be printed, settings of the print job are displayed on the local user interface 7, respectively the local user interface 7A-7C. The elucidation hereinafter assumes the settings of the print job to be displayed at the local user interface of the reproduction apparatus. However, embodiments showing the settings of a print job on a work station arranged in the network N, e.g. on a window of a suitable printer driver, are not excluded from the scope of the present invention.

The reproduction apparatus according to the present invention may be an electro-photographical printer, an inkjet printer, or any other kind of reproduction apparatus. An embodiment of the reproduction apparatus manipulates sheets of receiving material. Another embodiment of the reproduction apparatus manipulates rolls of receiving material. Receiving material may be paper, textile, metal plates, printed circuit plates, solar cell plates, overhead sheet material, plastic or any other kind of suitable receiving material or substrate. The reproduction apparatus may comprise finishing options. However, finishing options of external finishing equipment may be arranged at the production system to finish a printed job and to deliver the printed job according to the wishes of a sender or a user of the print job.

The display and activating device 7, 7A, 7B, 7C will be further elaborated.

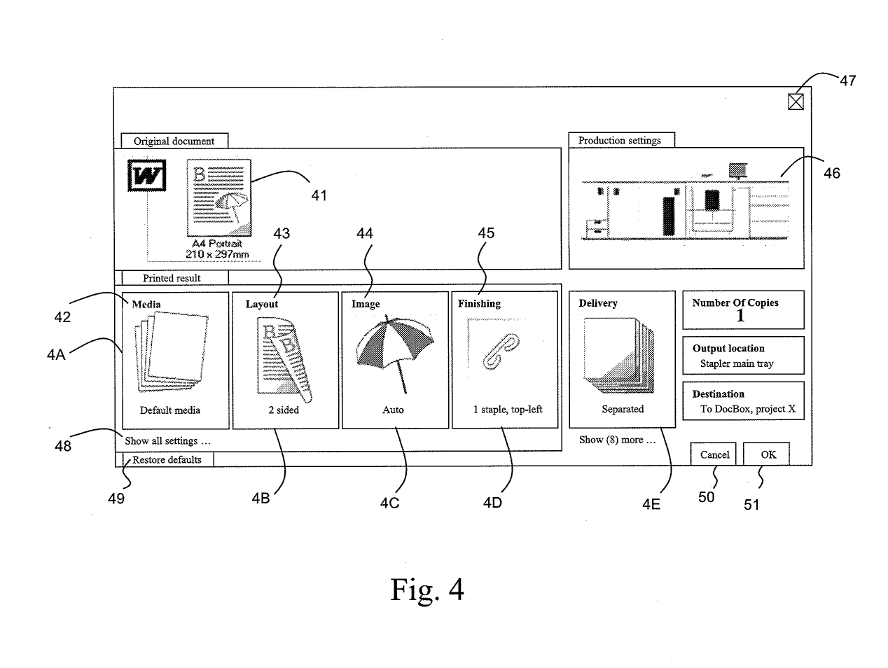

The display and activating device is suitable for displaying on a screen a visual representation of the settings of the print job and for selecting values of the settings of the print job. FIG. 4 shows a window to be displayed at the display and activating device according to the present invention.

On a right, top of the window, a cross button 47 is displayed for leaving this window. On a bottom, right corner of the window, a cancel button 50 is available also for leaving this window without saving any changes made on the window. On the bottom, right corner of the window, a confirmation button 51 is available for confirming any changes made on the screen and saving these changes in the memory of the control unit of the reproduction apparatus.

In a first segment of the window called “Original document” a, possible symbolic, image 41 of the at least one original document of the print job to be printed is shown. A size and an orientation of an original document is added in text format.

A second segment of the window called “Production settings” comprises an image 46 showing the configuration of the reproduction apparatus, a delivery category button 4E showing a selected delivery category option (“Separated”), and three additional boxes for selecting a number of copies, an output location, e.g. a stapler main tray, and a destination, e.g. for scanning to a document box on a dedicated work station. The delivery category button 4E has a title with text “Delivery”.

A third segment of the window called “Printed result” comprises four settings category buttons 4A-4D. A media category button 4A shows a selected media category option (i.e. “Default media”). The media category button 4A has a title 42 with text “Media.” A layout category button 4B shows a selected layout category option (e.g. “2 sided”). The layout category button 4B has a title 43 with text “Layout.” An image category button 4C shows a selected image category option (i.e. “Auto”). The image category button 4C has a title 44 with text “Image.” A finishing category button 4D shows a selected finishing category option (“1 staple, top-left”). The finishing category button 4D has a title 45 with text “Finishing.”

Each settings category is defined by an aspect of the print job, in this case Media, Layout, Image, Finishing and Delivery, respectively shown by the settings category buttons 4A-4E. Each settings category has a list of category options, stored in the memory of the control unit of the reproduction apparatus. The lists of category options are mutually exclusive. A category option is identified by a given name. Each list of category options is predefined for the reproduction apparatus, but may be extended by means of the display and activating device.

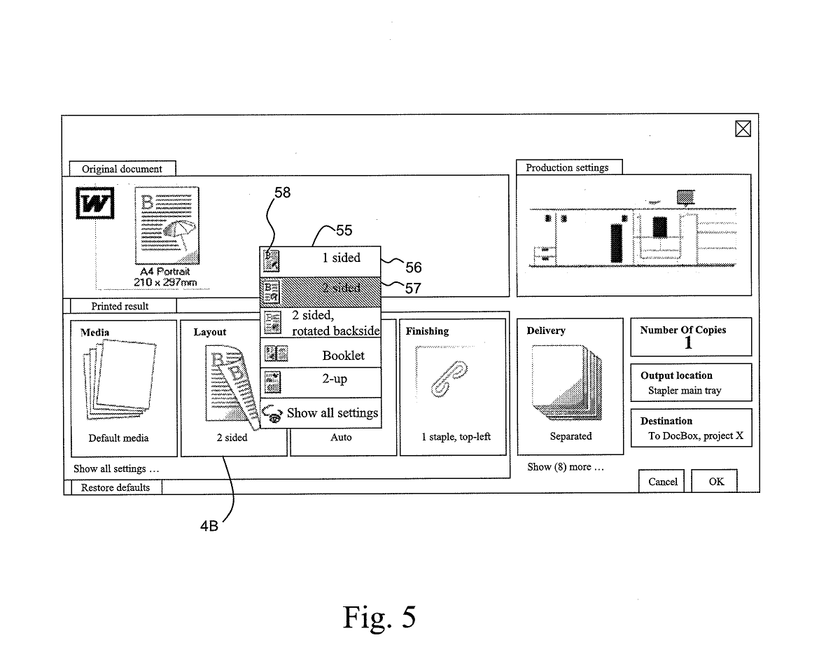

By activating a category button 4A-4E, a list (also referred to as a menu) of category options associated with the settings category is shown. In FIG. 5, the layout category button 4B has been activated, e.g. by touching or pushing, and the associated category option list 55 is shown. Each entry 56, 57 of the category option list is selectable. In FIG. 5, an area of a second entry 57 (“2 sided”) is dashed, because it has been selected. This is also clear from the image on the layout category option button 2B (“2 sided”) indicating the selected layout category option.

Each entry also comprises a distinguishing image 58 for a fast recognition of the intent of the category option by a user of the display and activating device.

Each entry 56, 57 of the list 55 may be selected to enable the associated category option become the category option to be applied for the print job under execution and any subsequent print job, as long as no other category option is selected.

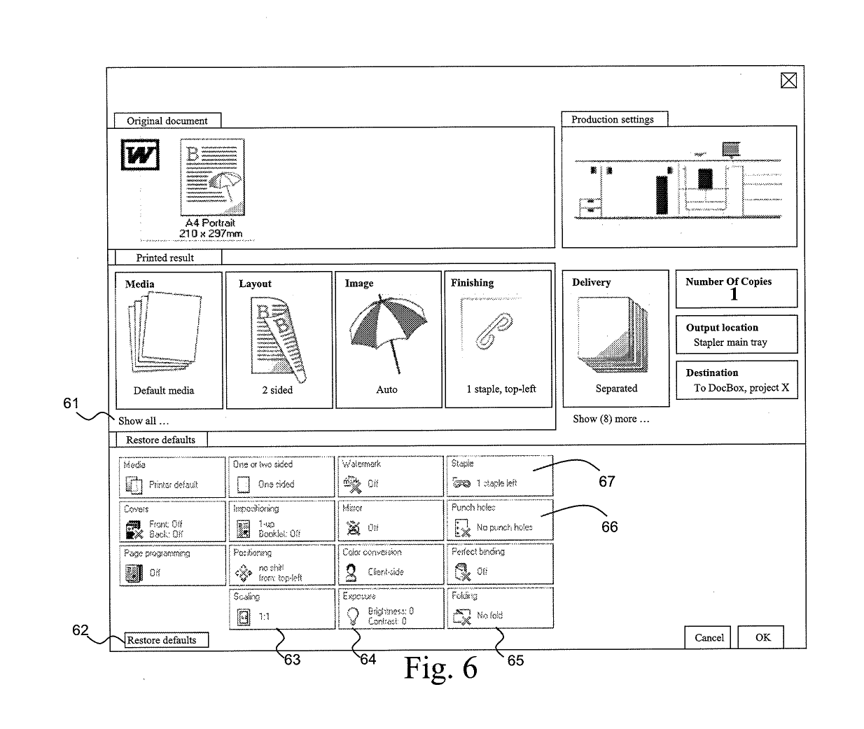

Below the third segment of the window in FIG. 4, an activatable message 48 is shown. The message 48 states “Show all settings.” When activating the message 48, for example by touching or pointing at, a plurality of, in this case 15, basic settings 63-67 becomes visible as shown in FIG. 6. The activatable message 48 changes into a shorter message 61. Each basic setting is settable to a value out of a set of at least one value. A set of values of the plurality of settings determines a category option. The plurality of category options may be created in such a way that each category option is determined by a unique set of values of the basic settings.

The basic settings may be divided into groups, each of which groups determine category options of a different settings category. However, basic settings that determine selected category options of different settings categories, may conflict with each other. In case of a conflict, the conflict will be resolved internally by the control system, which has a priority system for resolving such conflicts, or by means of a pop-up menu in order to invite the user of the display and activating device, to make a change to at least one relevant basic setting of at least one relevant category option.

On top of the plurality of basic settings on the window, a first restore button 49 (See FIG. 4) is shown, as well as on the bottom of the plurality of basic settings on the window, a second restore button 62 (See FIG. 6) is shown. By activating one of the first or second restore button 49, 62, each value of a setting of the plurality of basic settings is reset to a corresponding default value.

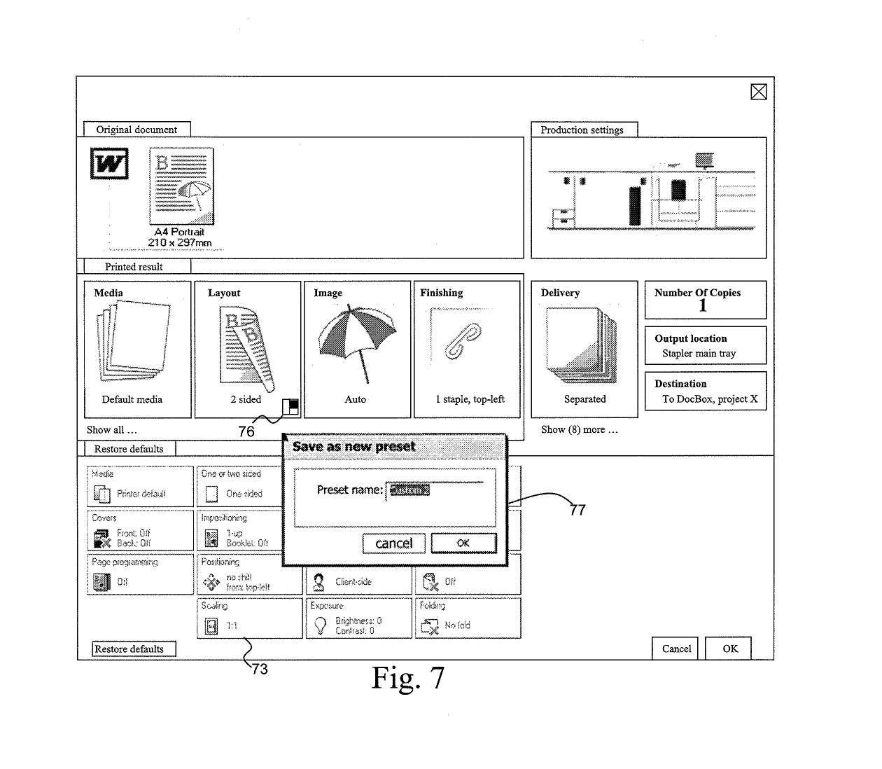

A value of a basic setting may be changed as shown in FIG. 7. For example, a setting 73 (63 in FIG. 6) “Scaling” is changed from 1:1 to 1:2. When the setting 73 is changed, an activatable save icon 76 will pop up in the layout category button indicating that the category option of the layout category which is selected, in this case “2 sided,” is changed. In order to save such a composition of basic settings in a new category option of the layout category, the save icon 76 may be pressed or otherwise activated and pop-up window 77 appears. In the pop-up window 77, a new category option may be addressed. When a category option of the list of the layout category already comprises exactly the new combination of settings, the name of that specific category option will be displayed in the pop-up window 77 in order to replace that category option with the new basic settings. When no category option of the list of the layout category comprises this new combination, the pop-up window 77 will ask for a new name for the category option. By clicking on the OK button of the pop-up window 77, the new category option will be saved in the list of category options belonging to the layout category. By clicking on the cancel button of the pop-up window 77, no new category option will be saved, and the previous value of the basic setting 77, which is “1:1”, will be shown again. By doing so, the user is able to create new category options, which are useful for printing documents that need a value set of settings which was not yet covered by any category option.

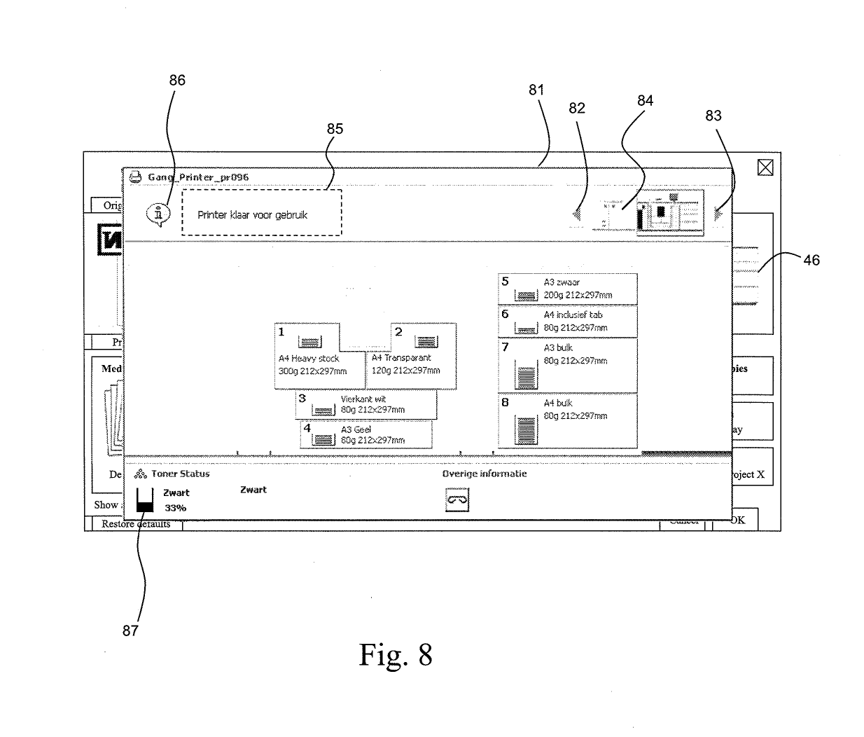

The second segment of the window in FIG. 4, called “Production settings” comprises an image 46 showing the configuration of the reproduction apparatus. The image may help to recognize which reproduction apparatus is connected. The image may be clicked on and FIG. 8 shows the result of clicking on the image 46. Clicking on the image zooms in at the reproduction apparatus, showing the most relevant part 81 of the reproduction apparatus closer. The relevant information 81 about this reproduction apparatus is displayed at the image 46, in the actual location, resulting in a virtual printer experience. Examples of printer info are: toner status, media availability, staples, paper jams/errors and delivery location. A miniature 84 of the entire reproduction apparatus configuration can be manipulated by means of two side arrows 82, 83 to determine the visible part of the reproduction apparatus. At this reproduction apparatus, a toner level 87 is indicated to be 33% below the relevant part 81.

A dashed location 85 is used for a user info message, for example “Printer klaar voor gebruik”, being Dutch for “Printer ready for use”. An info icon 86 is positioned in front of the message.

In case of an important warning/error, an alert bar may become visible at the image in the second segment of the window on the location 85, attracting more attention to the status of the reproduction apparatus. In this case, the info icon 86 may be replaced by a warning icon. After clicking on the alert bar, again the most relevant part of the printer becomes visible, but now with additional details on the warning. The additional details are displayed in an additional info window.

In case information becomes relevant (e.g. because of a warning/error) while the additional info window is opened, and a new event related to the relevant information is not in the visible part of the reproduction apparatus at that time, software on the control means could automatically change the visible part of the reproduction apparatus to make the new event visible.

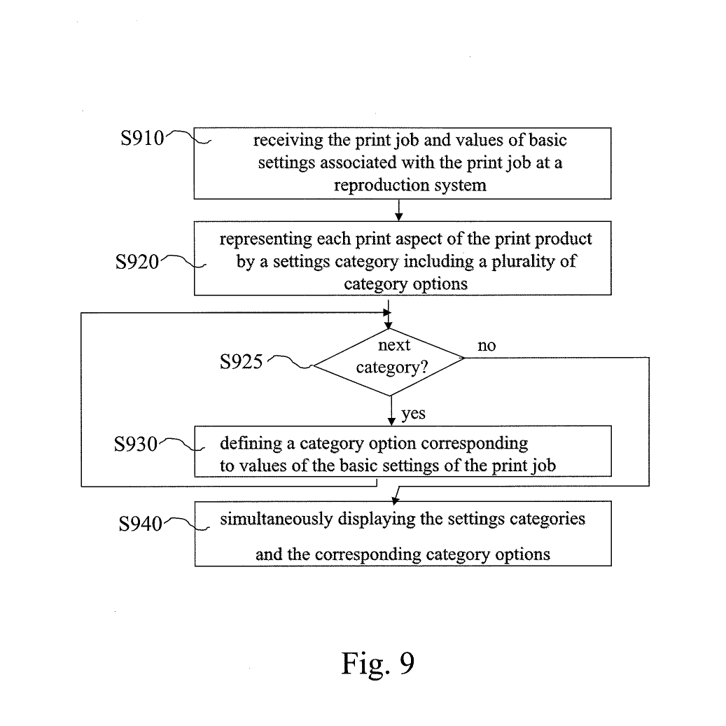

Another aspect of the invention is the method for printing a print job on a reproduction system resulting in a print product according to a plurality of print aspects describing the complete print product. An embodiment of such a method is shown in FIG. 9.

According to the embodiment the method comprises a first step S910 of receiving the print job and values of basic settings associated with the print job at a reproduction system. In a second step S920 each print aspect of the print product is represented by a settings category including a plurality of category options. In a decision step S925 it is checked if a third step S930 has been applied to all settings categories. If there is still a settings category left, the third step S930 is executed. The third step S930 defines for the particular settings category a category option corresponding to values of the basic settings of the print job. In a fourth step S940, the settings categories and the corresponding category options are simultaneously displayed for the user. In a last step S950, the print job is printed according to current category options.

The method according to the present invention may comprise at least one of the following additional steps. According to a first additional step, each settings category is shown by means of an icon representing its corresponding category option. According to a second additional step, the plurality of basic settings and the category options are displayed in one window upon user command. According to a third additional step, a selection of category options for a settings category is displayed upon user command. According to a last additional step, a category option of a settings category is changed and saved upon user command.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A reproduction system, comprising:
at least one printer for printing a print job on receiving material, resulting in a print product in accordance with a set of values for a plurality of basic settings, said values associated with the print job;
a control configured to control the print job in order to print the print job by the at least one printer according to the set of values of the basic settings; and
a display and activating device configured to display a visual representation of settings for the print job on a screen and activate values of the basic settings for the print job,
wherein the control is configured to define a plurality of settings categories, each of the settings categories being directed to an aspect of the print product and including a predetermined category option that determines a set of values for a plurality of basic settings, said category options for the settings categories together completely describing the print product, and
wherein the display and activating device is configured to simultaneously display the complete plurality of settings categories, each of the plurality of settings categories showing the corresponding category option.

2. The reproduction system according to claim 1 wherein each of the plurality of settings categories has a selection list of category options.

3. The reproduction system according to claim 2, wherein the display and activating device is configured to display on one window each settings category by means of an icon of the predetermined category option associated with the settings category.

4. The reproduction system according to claim 1, wherein the display and activating device is configured to display the plurality of basic settings in the one window upon user command.

5. The reproduction system according to claim 3, wherein the display and activating device is configured to show the selection list of a settings category upon user command, when activating an icon of the settings category, and to activate a category option from the shown selection list.

6. The reproduction system according to claim 1, wherein the display and activating device is configured to simultaneously display the selected category options and the plurality of basic settings in one window upon user command.

7. The reproduction system according to claim 1, wherein the display and activating device is configured to create a new category option by saving values of current basic settings.

8. The reproduction system according to claim 1, wherein a settings category is directed to one print aspect from media, layout, image, finishing and delivery of a print product.

9. A method for printing a print job on a reproduction system, resulting in a print product according to a plurality of print aspects describing the complete print product, said method comprising the steps of:
a) receiving the print job and values of basic settings associated with the print job at a reproduction system;
b) representing each print aspect of the print product by a settings category including a plurality of category options;
c) for each settings category, defining a category option corresponding to values of the basic settings of the print job;
d) simultaneously displaying the settings categories and the corresponding category options; and
e) printing the print job according to current category options.

10. The method according to claim 9, further comprising the steps of:
displaying a selection list of category options upon activation of a settings category; and
activating a category option from the selection list.

11. The method according to claim 9, further comprising the step of changing and saving a category option of a settings category upon user command.

12. The method according to claim 1, further comprising the step of creating a new category option by saving values of current basic settings.
